(19) United States
(12) Patent Application Publication
(10) Pub. No.: US 2021/0096980 A1
(43) Pub. Date: Apr. 1, 2021

(54) METHOD AND SYSTEM FOR PERFORMING EXPLORATORY TESTING OF AN APPLICATION UNDER TEST (AUT)

(71) Applicant: Wipro Limited, Bangalore (IN)

(72) Inventor: Melwyn Anthony DSOUZA, Bangalore (IN)

(21) Appl. No.: 16/711,691

(22) Filed: Dec. 12, 2019

(30) Foreign Application Priority Data
Oct. 1, 2019 (IN) 201941039656

(51) Int. Cl. G06F 11/36; G06N 20/00

(52) U.S. Cl. CPC G06F 11/3688; G06N 20/00; G06F 11/368; G06F 11/3664

(57) ABSTRACT

The present disclosure is related to field of testing, that discloses method and system for performing exploratory testing of an Application Under Test (AUT). An application testing system may receive input data comprising a plurality of pre-stored test cases and requirement data of the AUT, from one or more data sources and may detect Graphical User Interface (GUI) control elements configured in the AUT. Subsequently, the application testing system may determine an action and an expected result of action associated with each of the GUI control elements based on plurality of pre-stored test cases and predefined basic control element data, based on which a plurality of test input combinations for each of the GUI control elements may be generated, in real-time. Further, the application testing system may execute each of the plurality of test input combinations on corresponding one or more GUI control elements, thereby performing exploratory testing of AUT.

### TECHNICAL FIELD

The present subject matter is related in general to the field of testing, and more particularly, but not exclusively to a method and a system for performing exploratory testing of an Application Under Test (AUT).

### BACKGROUND

Testing is a process of evaluating functionality of an application with an intent of identifying whether the developed application meets the specified requirements, and identifying defects in the application to ensure that a product configured with the application is defect free. In testing, exploratory testing is a powerful testing approach where the Application Under Test (AUT) is subjected to random, un-scripted and ad-hoc operations. Due to this nature of the approach, exploratory testing generally yields more defects than traditional scripted test cases. However, exploratory testing is extremely time consuming, since it is a manual process, which requires a tester to manually execute, observe and validate each test step. Testing teams generally are provided with limited time for testing the applications, which would generally be insufficient to complete the testing using scripted tests cases itself. Therefore, in most of the cases, since there would not he enough time or resources for performing exploratory testing, testers tend to avoid exploratory testing of the AUT. This is a major drawback, as the testers may tend to miss out performing useful tests of the AUT, leading to a situation where defects in the AUT are left unseen, which directly affect the quality of the product.

One of the existing techniques discloses a method of automatically testing different software applications for defects. This technique converts recorded test scripts into a generic format that is not application-centric and stores the resultant non-application centric data in generic data containers. In this technique, it is mandatory for a tester to initially perform testing on the application, which can be performed only when recorded test scripts required for testing the application, are stored in the system. Therefore, having a test script and a test plan prior to testing is a mandatory feature of this technique, which could be extremely time consuming. In addition, scope of the testing using such technique would be restricted only to the recorded test scripts, which contradicts the principle of exploratory testing.

Another existing technique discloses software testing that follows no-script approach based on Artificial Intelligence (AI). This technique teaches about the combination of very high quality, mature, lexical analysis of live web pages and sophisticated machine learning for test creation. The platform disclosed in this existing technique ingests a written test plan or user journey using Natural Language Processing (NLP) engine and outputs tests that are ready to be executed across multiple browser platforms. In order to use this platform, the user may have to write elaborate test plans that requires huge resources. Further, in this technique the exploratory testing is performed only according to the test plan written by the user, therefore, if the user misses any tests in the test plans, it may lead to poor code coverage and incomprehensive testing.

### SUMMARY

Disclosed herein is a method of performing exploratory testing of an Application Under Test (AUT). The method includes receiving input data from one or more data sources. The input data comprises a plurality of pre-stored test cases and requirement data of an Application Under Test (AUT). Further, the method includes detecting one or ore Graphical User Interface (GUI) control elements configured in the AUT. Subsequently, the method includes determining an action and an expected result of the action associated with each of the one or more GUI control elements based on the plurality of pre-stored test cases and predefined basic control element data stored in the application testing system. Further, the method includes generating a plurality of test input combinations for each of the one or more GUI control elements, in real-time, based on, the determined action and the expected result of the action associated with each of the one or more GUI control elements, and the requirement data of the AUT. Finally, the method includes executing each of the plurality of test input combinations on the corresponding one or more GUI control elements, thereby performing exploratory testing of the AUT.

Further, the present disclosure includes an application testing system for performing exploratory testing of an Application Under Test (AUT). The application testing system includes a processor and a memory communicatively coupled to the processor. The memory stores the processor-executable instructions, which, on execution, causes the processor to receive input data from one or more data sources. The input data comprises a plurality of pre-stored test cases and requirement data of an Application Under Test (AUT). Further, the processor detects one or more Graphical User Interface (GUI) control elements configured in the AUT. Subsequently, the processor determines an action and an expected result of the action associated with each of the one or more GUI control elements based on the plurality of pre-stored test cases and predefined basic control element data stored in the application testing system. Further, the processor generates a plurality of test input combinations for each of the one or more GUI control elements, in real-time, based on, the determined action and the expected result of the action associated with each of the one or more GUI control elements, and the requirement data of the AUT. Finally, the processor executes each of the plurality of test input combinations on the corresponding one or more GUI control elements, thereby performing exploratory testing of the AUT.

Furthermore, the present disclosure comprises a non-transitory computer readable medium including instructions stored thereon that when processed by at least one processor causes an application testing system to receive input data from one or more data sources. The input data comprises a plurality of pre-stored test cases and requirement data of an Application Under Test (AUT). Further, the instructions cause the processor detect one or more Graphical User Interface (GUI) control elements configured in the AUT. Furthermore, the instructions cause the processor to determine an action and an expected result of the action associated with each of the one or more GUI control elements based on the plurality of pre-stored test cases and predefined basic control element data stored in the application testing system. In addition, the instructions cause the processor to generate a plurality of test input combinations for each of the one or more GUI control elements, in real-time, based on, the determined action and the expected result of the action associated with each of the one or more GUI control elements, and the requirement data of the AUT. Finally, the instructions cause the processor to execute each of the plurality of test input combinations on the corresponding cine or is ore GUI control elements, thereby performing exploratory testing of the AUT.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary architecture for performing exploratory testing of an Application Under Test (AUT) in accordance with some embodiments of the present disclosure;

FIG. 2A shows a detailed block diagram of an application testing system for performing exploratory testing of an Application. Under Test (AUT) in accordance with some embodiments of the present disclosure;

FIG. 2B shows an exemplary AUT in accordance with some embodiments in the present disclosure;

FIG. 2C shows an exemplary Graphical User Interface (GUI) control elements in accordance with some embodiments in the present disclosure;

FIG. 3 shows a flowchart illustrating a method of performing exploratory testing of an Application Under Test (AUT) in accordance with some embodiments of the present disclosure; and

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject r natter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure provides a method and a system for performing exploratory testing of an Application Under Test (AUT). An application testing system may receive input data from one or more data sources. The input data may include, but not limited to, a plurality of pre-stored test cases and requirement data of the AUT. In some embodiments, the application testing system may detect one or more Graphical User Interface (GUI) control elements configured in the AUT. Upon detecting the one or more GUI control elements, the application testing system may determine an action and an expected result of the action associated with each of the one or more GUI control elements based on the plurality of pre-stored test cases and predefined basic control element data stored in the application testing system. Further, the application testing system may generate a plurality of test input combinations for each of the one or more GUI control elements, in real-time, based on, the determined action and the expected result of the action associated with each of the one or more GUI control elements, and the requirement data of the AUT. Upon generating the plurality of test input combinations, the application testing system may execute each of the plurality of test input combinations on the corresponding one or more GUI control elements, to perform the exploratory testing of the AUT.

The present disclosure enables automatic generation of plurality of test input combinations based on actions associated the GUI control elements, for performing the exploratory testing. Therefore, the number of resources and the time consumed for generating the test input combinations is substantially reduced when compared to the conventional exploratory testing where the testers have to manually execute, observe and validate test input combinations. Further, the present disclosure enables generating of plurality of test input combinations without the need of a written test plan as observed in the existing art. Since, the present disclosure is independent of written test plans or test scripts, the present disclosure ensures enhanced test/scenario coverage and comprehensive testing, thereby improving quality of a product in which the AUT is configured. Further, the present disclosure automatically records the plurality of test input combinations, corresponding execution steps and determined defects and generate test scripts, for future use. Overall, the present disclosure makes it possible for the testers to subject the AUT to exploratory testing within the limited time provided for testing, thereby enhancing the test/scenario coverage and testing quality.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

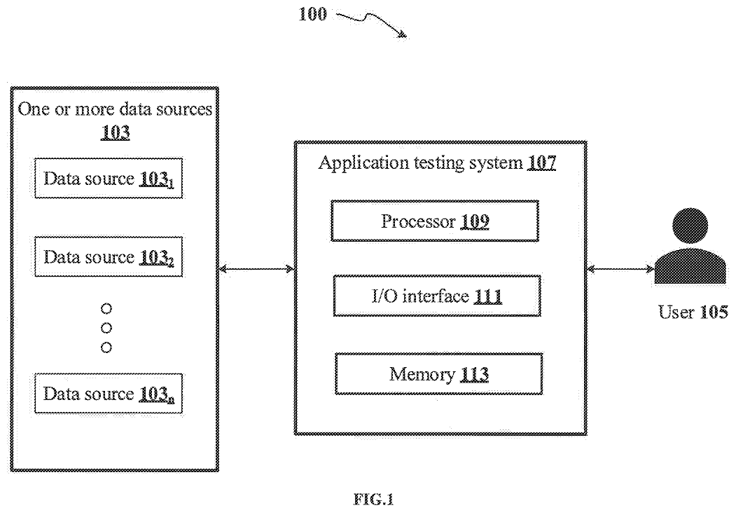

FIG. 1 shows an exemplary architecture for performing exploratory testing of an Application Under Test (AUT) in accordance with some embodiments of the present disclosure.

The architecture 100 includes data source 103₁ to data source 103ₙ (also referred to as one or more data sources 103), a user 105 and an application testing system 107. The one or more data sources 103 may be associated with the application testing system 107 via a communication network (not shown in the FIG. 1). The communication network may be at least one of a wired communication network and wireless communication network. The one or more data sources 103 may include, but not limited to, a test case database and a requirement database, In some embodiments, the test case database may include, but not limited to, a plurality of pre-stored test cases. In some embodiments, the requirement database may include, but not limited to, requirement data. The requirement data may include, but not limited to, one or more requirements of the Application Under Test (AUT) and predefined policies related to the AUT.

The application testing system 107 may include a processor 109, an Input/Output (I/O) interface 111 and a memory 113. The I/O interface 111 may receive input data from the one or more data sources 103. As an example, the input data may include, but riot limited to, the plurality of pre-stored test cases and the requirement data of the AUT. The processor 109 may scan the AUT to detect one or more Graphical User Interface (GUI) control elements configured in the AUT. As an example, the GUI control elements may include, but not limited to, a button such as a radio button, push button and the like, checkboxes, drop-down list, list box, a scrollbar, a text box, tabs, icons and the like. In some embodiments, the one or more GUI elements may be detected using one or more cognitive techniques. As an example, the one or more cognitive techniques may include, but riot limited to, image recognition techniques and natural language processing techniques. Upon detecting the one or more GUI elements, the processor 109 may determine an action and an expected result of the action associated with each of the one or more GUI control elements based on the plurality of pre-stored test cases and predefined basic control element data stored in the application testing system 107. In some embodiments, the action and the expected result of the action associated with each of the one or more GUI control elements may be determined using one or more deep learning techniques. In some embodiments, the predefined basic control element data may include, but not limited to, definition and functionality of one or more GUI control elements. Further, the processor 109 may generate a plurality of test input combinations for each of the one or more GUI control elements, in real-time, based on, the determined action and the expected result of the action associated with each of the one or more GUI control elements, and the requirement data of the AUT. Further, the processor 109 may execute each of the plurality of test input combinations on the corresponding one or more GUI control elements to perform exploratory testing of the AUT. Upon performing the exploratory testing, the processor 109 may record test data corresponding to execution of each of the plurality of test input combinations. The test data comprises plurality of steps performed by the application testing system to execute the corresponding plurality of test input combinations, metadata generated during the execution, and result of the execution. Subsequently, the processor 109 may analyse the test data recorded for each of the plurality of test input combinations to determine one or more defects in the AUT. Further, the processor 109 may generate a report indicating the one or more defects and images related to the one or more defects. The report may be transmitted to at least one user 105 associated with the application testing system 107. The processor 109 may receive an input from the at least one user 105 in response to the report transmitted to the at least one user 105. In some embodiments, the received input of the at least one user 105 and the report are used for incremental training of the application testing system 107. Also, the processor 109 may generate one or more new test cases based on the test data and the determined one or more defects. In some embodiments, the one or more new test cases may be used for testing other applications analogous to the AUT.

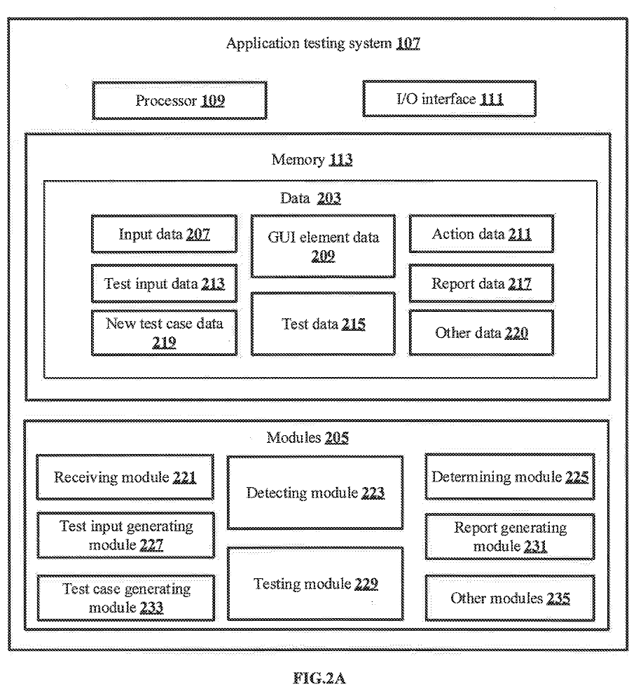

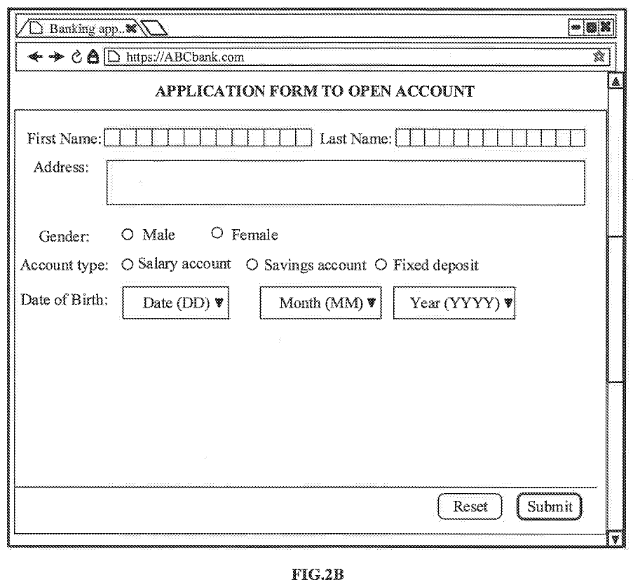

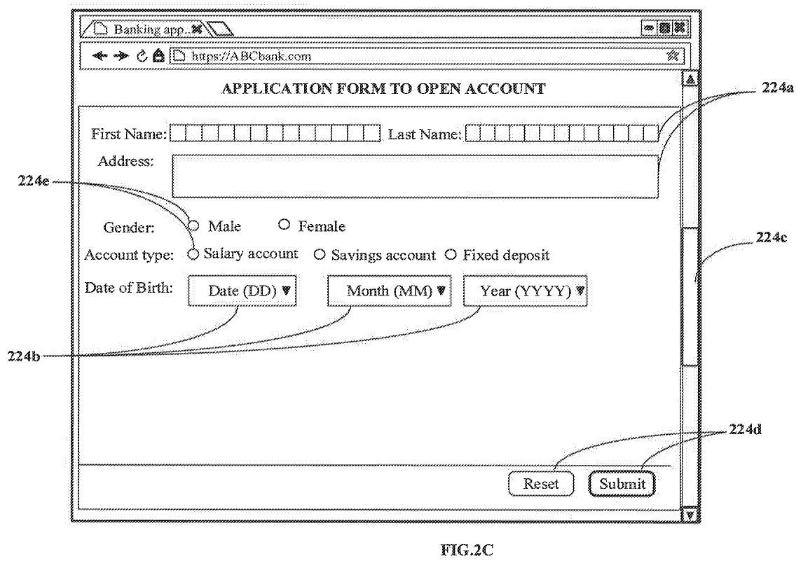

FIG. 2A shows a detailed block diagram of an application testing system for performing exploratory testing of an Application Under Test (AUT) in accordance with some embodiments of the present disclosure.

In some implementations, the application testing system 107 may include data 203 and modules 205. As an example, the data 203 is stored in the memory 113 configured in the application testing system 107 as shown in the FIG. 2A. In one embodiment, the data 203 may include input data 207, Graphical User Interface (GUI) element data 209, action data 211, test input data 213, test data 215, report data 217, new test case data 219 and other data 220. In the illustrated FIG. 2A, the modules 205 are described herein in detail.

In some embodiments, the data 203 may be stored in the memory 113 in form of various data structures. Additionally, the data 203 can be organized using data models, such as relational or hierarchical data models. The other data 220 may store data, including temporary data and temporary files, generated by the modules 205 for performing the various functions of the application testing system 107.

In some embodiments, the data 203 stored in the memory 113 may be processed by the modules 205 of the application testing system 107. The modules 205 may be stored within the memory 113. In an example, the modules 205 communicatively coupled to the processor 109 configured in the application testing system 107, may also be present outside the memory 113 as shown in FIG. 2A and implemented as hardware. As used herein, the term modules 205 may refer to an application specific integrated circuit (ASIC), an electronic circuit, a processor (shared, dedicated, or group) and memory that execute one or more software or firmware programs, a combinational logic circuit, and/or other suitable components that provide the described functionality.

In some embodiments, the modules 205 may include, for example, a receiving module 221, a detecting module 223, a determining module 225, a test input generating module 227, a testing module 229, a report generating module 231, a test case generating module 233 and other modules 235. The other modules 235 may be used to perform various miscellaneous functionalities of the application testing system 107. It will be appreciated that such aforementioned modules 205 may be represented as a single module or a combination of different modules.

In some embodiments, the receiving module 221 may receive input data 207 from one or more data sources 103. In some embodiments, the input data may include, but not limited to, a plurality of pre-stored test cases and requirement data of the AUT. In some embodiments, the plurality of pre-stored test cases may be test cases, which were executed previously for testing one or more different applications. In some embodiments, the one or more different applications may be analogous to the AUT. The requirement data of the AUT may include, but not limited to, one or more requirements of the AUT and predefined policies related to the AUT. As an example, consider the AUT is a banking application. One of the mandatory requirement to open a bank account using the banking application could be that the user should be above the age of 18 years. Therefore, this requirement related to age of the user may be stored as the requirement data.

Further, in some embodiments, the detecting module 223 may scan the Application Under Test (AUT) to detect one or more GUI control elements configured in the AUT. In some embodiments, the one or more GUI control elements may include, but not limited to, a button such as a radio button, push button and the like, checkboxes, drop-down list, list box, a scrollbar, a text box, tabs, icons and the like. As an example, the detected one or more GUI control elements may be stored as the GUI element data 209. Consider a banking application as the AUT, which includes an exemplary banking application form as shown in the FIG. 2B. The detecting module 223 scans the banking application form using one or more cognitive techniques to detect the one or more GUI control elements in the banking application form. As an example, the one or more cognitive techniques may include, but not limited to, image recognition techniques, natural language processing techniques and the like. In this scenario, upon scanning the banking application form, the one or more GUI control elements detected by the detecting module 223 are a text box 224a, a drop-down list 224b, a scroll bar 224c, a push button 224d and a radio button 224e as shown in the FIG. 2C. In some embodiments, the one or more GUI control elements detected by the detecting module 223 may be stored as the GUI element data 209.

Further, in some embodiments, the determining module 225 may determine an action and an expected result of the action associated with each of the one or more GUI control elements based on the plurality of pre-stored test cases and predefined basic control element data stored in the application testing system 107. The predefined basic control element data may include, but not limited to, basic information such as definition and function of the one or more GUI control elements. As an example, a button represented with a cross mark may be defined as a cross button and the functionality of the cross button as closing current window of the application. In some embodiments, the action and the expected result of the action associated with each of the one or more GUI control elements may be determined using one or more deep learning techniques, based on the plurality of pre-stored test cases. As an example, consider the banking application form as shown in FIG. 2C. The push button 224d with the title “Submit” may be clicked for submitting the banking application form. As an example, result of the action “clicking” of the push button 224d titled “submit” may include indicating a page of the application with a notification “Thank you. Your application form has been successfully submitted”. Therefore, when the detection module 222 detects the presence of a push button 224d titled “Submit”, the determining module 225 may correlate the detected GUI control element with the one or more pre-stored test cases and the predefined basic control element data using the one or more deep learning techniques to determine the action and the result of the action. In this scenario, the determining module 225 may determine the action of the push button 224d titled “Submit” as submitting the application form and the expected result of the action as, showcasing a page of the application having a notification related to submission of the application form. In some embodiments, the action and the expected result of the action determined by the determining module 225 is stored as the action data 211.

Further, the test input generating module 227 may generate a plurality of test input combinations for each of the one or more GUI control elements, in real-time. In some embodiments, the test input generating module 227 may generate the plurality of test input combinations based on the determined action and the expected result of the action associated with each of the one or more GUI control elements and the requirement data of the AUT. As an example, consider a banking application as the AUT, which includes a banking application form. As an example, consider, the banking application form detected 6 GUI control elements and each GUI control element can be subjected to 5 different values. In such scenario, the total number of test input combinations may be more than 15,000 combinations, consider “n” combinations. The test input generating module 227 may generate each of the plurality of test input combinations automatically, in real-time, for each of the detected one or more GUI control elements. In some embodiments, the plurality of test input combinations generated for each of the one or more GUI control elements may be stored as the test input data 213.

Upon generating the plurality of test input combinations, the testing module 229 may execute each of the plurality of the test input combinations on the corresponding one or more GUI control elements to perform exploratory testing of the AUT. In some embodiments, since the actions and the expected result of the action is known to the application testing system 107, the testing module 229 may understand which test input combination is a valid combination and an invalid combination. In some embodiments, execution of the plurality of test input combinations may generate the test data 215. The test data 215 may include, but not limited to, a plurality of steps performed by the testing module 229 to execute the corresponding plurality of test input combinations, metadata generated during the execution, and result of the execution. Further, the testing module 229 may analyse the test data 215 generated by executing each of the plurality of test input combinations to determine one or more defects and bugs in the AUT. In some embodiments, the testing module 229 may record the test data 215 corresponding to execution of only the plurality of test input combinations, in which the one or more defects or bugs are detected. In some other embodiments, the testing module 229 may record the test data 215 corresponding to execution of each of the plurality of test input combinations, irrespective of the one or more defects or bugs.

Further, the report generating module 231 may generate a report indicating the one or more defects and images related to the one or more defects. In some embodiments, the images related to the one or more defects may be screenshots of the one or more defects detected by the testing module 229 during analysis. The report generated by the report generating module 231 may be stored as the report data 217. Further, the report generating module 231 may transmit the report to at least one user 105 associated with the application testing system 107. In some embodiments, the at least one user 105 may be a tester or subject matter expert. In response to the report transmitted to the at least one user 105, the report generating module 231 may receive an input from the at least one user 105 related to the correctness of the one or more defects or bugs determined by the testing module 229. In some embodiments, the received input of the at least one user 105 and the generated report may be used for incremental training of the application testing system 107.

Further, the test case generating module 233 may generate one or more new test cases based on the test data 215 and the determined one or more defects. In some embodiments, the one or more new test cases may be used for testing other applications analogous to the AUT, in future. In some embodiments, the applications analogous to the AUT may even include different versions of the AUT. The one or more new test cases thus generated may be stored as the new test case data 219. In some other embodiments, the one or more new test cases may be stored in the test case database associated with the application testing system 107.

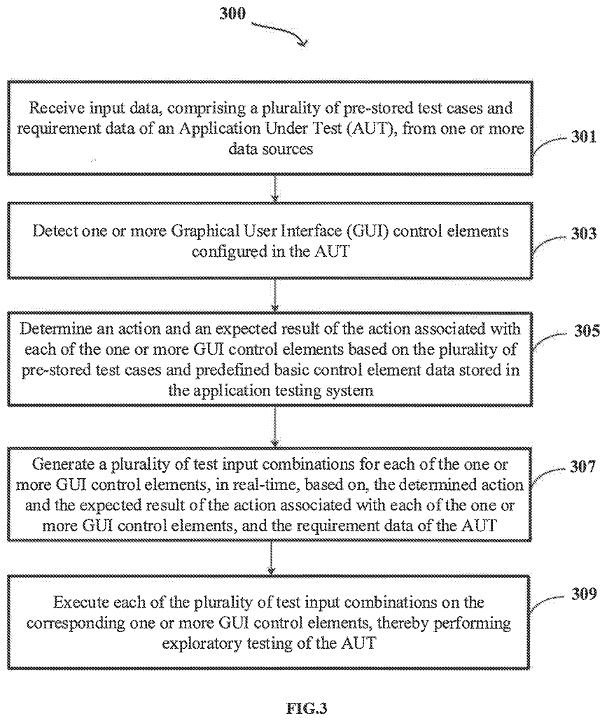

FIG. 3 shows a flowchart illustrating method of performing exploratory testing of an Application Under Test (AUT) in accordance with some embodiments of the present disclosure.

As illustrated in FIG. 3, the method 300 comprises one or more blocks illustrating a method of performing exploratory testing of an Application Under Test (AUT). The method 300 may be described in the general context of computer executable instructions. Generally, computer executable instructions can include routines, programs, objects, components, data structures, procedures, modules, and functions, which perform functions or implement abstract data types.

The order in which the method 300 is described is not intended to be construed as a limitation, and any number of the described method blocks can be combined in any order to implement the method 300. Additionally, individual blocks may be deleted from the methods without departing from the spirit and scope of the subject matter described herein. Furthermore, the method 300 can be implemented in any suitable hardware, software, firmware, or combination thereof.

At block 301, the method 300 may include receiving, by a processor 109 of an application testing system 107, input data from one or more data sources. In some embodiments, the input data may include, but not limited to, a plurality of pre-stored test cases and requirement data of the AUT.

At block 303, the method 300 may include detecting, by the processor 109, one or more Graphical User Interface (GUI) control elements configured in the AUT. As an example, the one or more GUI control elements may be a button such as a radio button, push button and the like, checkboxes, drop-down list, list box, a scrollbar, a text box, tabs, icons and the like. In some embodiments, the one or more GUI elements may be detected using one or more cognitive techniques. As an example, the one or more cognitive techniques may include, but not limited to image recognition techniques and natural language processing techniques.

At block 305, the method 300 may include determining, by the processor 109, an action and an expected result of the action associated with each of the one or more GUI control elements based on the plurality of pre-stored test cases and predefined basic control element data stored in the application testing system 107. In some embodiments, the action and the expected result of the action associated with each of the one or more GUI control elements are determined using one or more deep learning techniques. Predefined basic control element data may include, but not limited to, basic information such as definition and function of the one or more GUI control elements.

At block 307, the method 300 may include generating, by the processor 109, a plurality of test input combinations for each of the one or more GUI control elements, in real-time, based on, the determined action and the expected result of the action associated with each of the one or more GUI control elements, and the requirement data of the AUT.

At block 309, the method 300 may include executing, by the processor 109, each of the plurality of test input combinations on the corresponding one or more GUI control elements, thereby performing exploratory testing of the AUT. Upon performing the exploratory testing, the processor 109 may record test data corresponding to execution of each of the plurality of test input combinations. The test data comprises plurality of steps performed by the application testing system to execute the corresponding plurality of test input combinations, metadata generated during the execution, and result of the execution. Subsequently, the processor 109 may analyse the test data recorded for each of the plurality of test input combinations to determine one or more defects in the AUT. Further, the processor 109 may generate a report indicating the one or more defects and images related to the one or more defects. The report may be transmitted to at least one user 105 associated with the application testing system 107. The processor 109 may receive an input from the at least one user 105 in response to the report transmitted to the at least one user 105. In some embodiments, the received input of the at least one user 105 and the report are used for incremental training of the application testing system 107. Also, the processor 109 may generate one or more new test cases based on the test data and the determined one or more defects. The one or more new test cases are used for testing other applications analogous to the AUT.

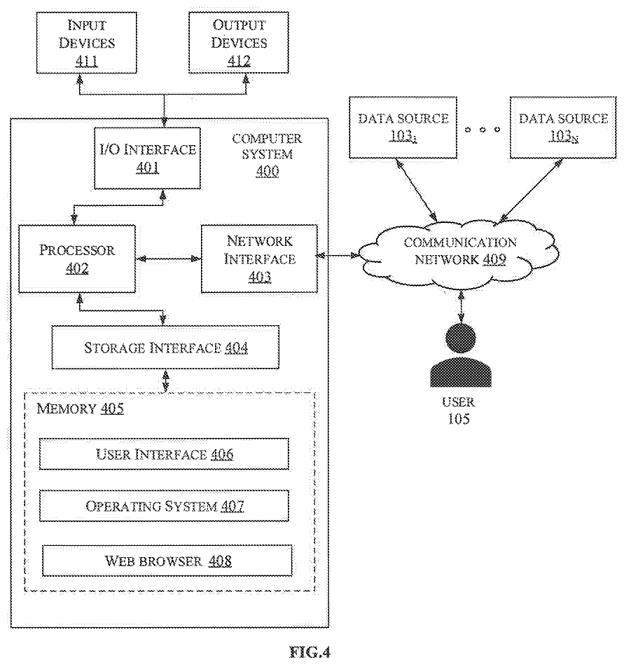

FIG. 4 is a block diagram of an exemplary computer system for implementing embodiments consistent with the present disclosure.

In some embodiments, FIG. 4 illustrates a block diagram of an exemplary computer system 400 for implementing embodiments consistent with the present invention. In some embodiments, the computer system 400 can he an application testing system 107 to perform exploratory testing of an Application Under Test (AUT). The computer system 400 may include a central processing unit (“CPU” or “processor”) 402. The processor 402 may include at least one data processor for executing program components for executing user or system-generated business processes. A user may include a person, a person using a device such as those included in this invention, or such a device itself. The processor 402 may include specialized processing units such as integrated system (bus) controllers, memory management control units, floating point units, graphics processing units, digital signal processing units, etc.

The processor 402 may be disposed in communication with input devices 411 and output devices 412 via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 401, computer system 400 may communicate with input devices 411 and output devices 412.

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with one or more data sources 103 (103₁ up to 103ₙ), and a user 105. The communication network 409 can be implemented as one of the different types of networks, such as intranet or Local Area Network (LAN), Closed Area Network (CAN) and such. The communication network 409 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, a user interface 406, an operating system 407, a web browser 408 etc. In some embodiments, the computer system 400 may store user/application data, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS®, GOOGLE™ ANDROID™, BLACKBERRY® OS, or the like. The User interface 406 may facilitate display, execution, interaction, manipulation, or operation of program components through textual or graphical facilities. For example, user interfaces may provide computer interaction interface elements on a display system operatively connected to the computer system 400, such as cursors, icons, checkboxes, menus, scroll rs, windows, widgets, etc. Graphical User Interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

In some embodiments, the computer system 400 may implement the web browser 408 stored program components. The web browser 408 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, ADOBE® FLASH®, JAVASCRIPT®, JAVA®, Application Programming Interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 400 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may he used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a system for performing exploratory testing of an Application Under Test (AUT). The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

Referral numerals

| Reference Number | Description |
|---|---|
| 100 | Architecture |
| 103 | One or more data sources |
| 105 | User |
| 107 | Application testing system |
| 109 | Processor |
| 111 | I/O interface |
| 113 | Memory |
| 203 | Data |
| 205 | Modules |
| 207 | Input data |
| 209 | GUI element data |
| 211 | Action data |
| 213 | Test input data |
| 215 | Test data |
| 217 | Report data |
| 219 | New test case data |
| 220 | Other data |
| 221 | Receiving module |
| 223 | Detecting module |
| 224a | Text box |
| 224b | Drop-down list |
| 224c | Scroll bar |
| 224d | Push down |
| 224e | Radio button |
| 225 | Determining module |
| 227 | Test input generating module |
| 229 | Testing module |
| 231 | Report generating module |
| 233 | Test case generating module |
| 235 | Other modules |
| 400 | Exemplary computer system |
| 401 | I/O Interface of the exemplary computer system |
| 402 | Processor of the exemplary computer system |
| 403 | Network interface |
| 404 | Storage interface |
| 405 | Memory of the exemplary computer system |
| 406 | User interface |
| 407 | Operating system |
| 408 | Web browser |
| 409 | Communication network |
| 411 | Input devices |
| 412 | Output devices |

What is claimed is:

1. A method of performing exploratory testing of an Application Under Test (AUT), the method comprising:
receiving, by an application testing system, input data from one or more data sources, wherein the input data comprises a plurality of pre-stored test cases and requirement data of an Application Under Test (AUT);
detecting, by the application testing system, one or more Graphical User Interface (GUI) control elements configured in the AUT;
determining, by the application testing system, an action and an expected result of the action associated with each of the one or more GUI control elements based on the plurality of pre-stored test cases and predefined basic control element data stored in the application testing system;
generating, by the application testing system, a plurality of test input combinations fur each of the one or more GUI control elements, in real-time, based on, the determined action and the expected result of the action associated with each of the one or more GUI control elements, and the requirement data of the AUT; and
executing, by the application testing system, each of the plurality of test input combinations on the corresponding one or more GUI control elements, thereby performing exploratory testing of the AUT.

2. The method as claimed in claim 1 further comprises recording test data corresponding to execution of each of the plurality of test input combinations, wherein the test data comprises plurality of steps performed by the application testing system to execute the corresponding plurality of test input combinations, metadata generated during the execution, and result of the execution.

3. The method as claimed in claim 2 further comprises analysing the test data recorded for each of the plurality of test input combinations to determine one or more defects in the AUT.

4. The method as claimed in claim 3 further comprises generating a report indicating the one or more defects and images related to the one or more defects, wherein the report is transmitted to at least one user associated with the application testing system.

5. The method as claimed in claim 3 further comprises generating one or more new test cases based on the test data and the determined one or more defects, wherein the one or more new test cases are used for testing other applications analogous to the AUT.

6. The method as claimed in claim 4 further comprises receiving an input from the at least one user in response to the report transmitted to the at least one user, wherein the received input of the at least one user and the report are used for incremental training of the application testing system.

7. An application testing system for performing exploratory testing of an Application Under Test (AUT), the application testing system comprising:
a processor; and
a memory communicatively coupled to the processor, wherein the memory stores the processor-executable instructions, which, on execution, causes the processor to:
receive input data from one or more data sources, wherein the input data comprises a plurality of pre-stored test cases and requirement data of an Application Under Test (AUT);
detect one or more Graphical User Interface (GUI) control elements configured in the AUT;
determine an action and an expected result of the action associated with each of the one or more GUI control elements based on the plurality of pre-stored test cases and predefined basic control element data stored in the application testing system (107);
generate a plurality of test input combinations for each of the one or more GUI control elements, in real-time, based on, the determined action and the expected result of the action associated with each of the one or more GUI control elements, and the requirement data of the AUT; and
execute each of the plurality of test input combinations on the corresponding one or more GUI control elements, thereby performing exploratory testing of the AUT.

8. The application testing system as claimed in claim 7, wherein the processor is further configured to record test data corresponding to execution of each of the plurality of test input combinations, wherein the test data comprises plurality of steps performed by the application testing system to execute the corresponding plurality of test input combinations, metadata generated during the execution, and result of the execution.

9. The application testing system as claimed in claim 8, wherein the processor is further configured to analyse the test data recorded for each of the plurality of test input combinations to determine one or more defects in the AUT.

10. The application testing system as claimed in claim 9, wherein the processor is further configured to generate a report indicating the one or more defects and images related to the one or more defects, wherein the report is transmitted to at least one user associated with the application testing system.

11. The application testing system as claimed in claim 9, wherein the processor is further configured to generate one or more new test cases based on the test data and the determined one or more defects, wherein the one or more new test cases are used for testing other applications analogous to the AUT.

12. The application testing system as claimed in claim 10, wherein the processor is further configured to receive an input from the at least one user in response to the report transmitted to the at least one user, wherein the received input of the at least one user and the report are used for incremental training of the application testing system.

13. A non-transitory computer readable medium including instructions stored thereon that when processed by at least one processor causes an application testing system to:
receive input data from one or more data sources, wherein the input data comprises a plurality of pre-stored test cases and requirement data of an Application Under Test (AUT);
detect one or more Graphical User Interface (GUI) control elements configured in the AUT;
determine an action and an expected result of the action associated with each of the one or more GUI control elements based on the plurality of pre-stored test cases and predefined basic control element data stored in the application testing system;
generate a plurality of test input combinations for each of the one or more GUI control elements, in real-time, based on, the determined action and the expected result of the action associated with each of the one or more GUI control elements, and the requirement data of the AUT; and
execute each of the plurality of test input combinations on the corresponding one or more GUI control elements, thereby performing exploratory testing of the AUT.
